(19) United States
(12) Patent Application Publication
(10) Pub. No.: US 2026/0086706 A1
(43) Pub. Date: Mar. 26, 2026

(54) METHOD FOR PROVIDING CONTENT DISPLAY PAGE, RELATED APPARATUS, ELECTRONIC DEVICE, COMPUTER-READABLE STORAGE MEDIUM AND COMPUTER PROGRAM PRODUCT

(71) Applicant: SHANGHAI BILIBILI TECHNOLOGY CO., LTD., Shanghai (CN)

(72) Inventors: Hanlu YE, Shanghai (CN); Qing LI, Shanghai (CN); Fan FEI, Shanghai (CN); Jing LU, Shanghai (CN); Wei JIANG, Shanghai (CN); Jiaqi LU, Shanghai (CN); Lihua HUANG, Shanghai (CN)

(21) Appl. No.: 19/312,700

(22) Filed: Aug. 28, 2025

(30) Foreign Application Priority Data
Sep. 24, 2024 (CN) 202411344443.2

(51) Int. Cl. G06F 3/0486

(52) U.S. Cl. CPC G06F 3/0486

(57) ABSTRACT

The application provides a method for providing a content display page, a related apparatus, and a computer program product, which are applied to a client. In the application, a content display page displayed in a first mode is displayed, where the content display page includes a content display area, and the content display area is correspondingly provided with a display mode switching control. In response to a trigger operation on the display mode switching control, a content display page displayed in a second mode is displayed, wherein the first mode and the second mode are display modes provided by a same client.

### TECHNICAL FIELD

The application relates to the field of computer technologies, and in particular, to a method and an apparatus for providing a content display page, an electronic device, a computer-readable storage medium, and a computer program product.

### BACKGROUND

With the development of society, Internet technologies are also increasingly advanced. The Internet serves as a platform that provides a user with resources and opportunities to communicate with other users, so that the user can obtain required resources through the Internet, and can communicate, exchange, and share content with other users.

For example, the user may watch, through the Internet, online videos provided by video platforms, or communicate, exchange, and share content with other users in a manner of publishing texts, pictures, and videos on the Internet. Therefore, how to provide the user with better content acquisition experience is of concern and urgent need.

### SUMMARY

In a plurality of aspects of the application, a method and an apparatus for providing a content display page, an electronic device, a computer-readable storage medium, and a computer program product are provided, which are applied to a client and can provide different display modes for a user, and allow the user to switch display modes as needed through a display mode switching control, so as to differentially meet content display requirements of different users and improve user experience.

According to an aspect of the application, a method for providing a content display page is provided, which is applied to a client and includes: displaying a content display page displayed in a first mode, where the content display page includes a content display area, and the content display area is correspondingly provided with a display mode switching control; and displaying, in response to a trigger operation on the display mode switching control, a content display page displayed in a second mode, where the first mode and the second mode are display modes provided by a same client.

According to another aspect of the application, an apparatus for providing a content display page is provided, which is applied to a client and includes: a first display unit, configured to display a content display page displayed in a first mode, wherein the content display page includes a content display area, and the content display area is correspondingly provided with a display mode switching control; and a second display unit, configured to display, in response to a trigger operation on the display mode switching control, a content display page displayed in a second mode, wherein the first mode and the second mode are display modes provided by a same client.

According to another aspect of the application, an electronic device is provided. The electronic device includes: at least one processor; and a memory that is communicatively connected to the at least one processor. The memory stores instructions executable by the at least one processor, and the instructions are executed by the at least one processor, so that the at least one processor can perform the method for providing a content display page provided above.

According to another aspect of the application, a computer-readable storage medium is provided. The computer-readable storage medium stores computer program instructions, and the computer program instructions are executable by a processor to implement the method for providing a content display page provided above.

According to another aspect of the application, a computer program product including a computer program is provided. The computer program product stores computer program instructions, and when the computer program is executed by a processor, the method for providing a content display page provided above can be implemented.

In the solutions provided in embodiments of the application, a content display page displayed in a first mode is displayed, where the content display page includes a content display area, and the content display area is correspondingly provided with a display mode switching control; and in response to a trigger operation on the display mode switching control, a content display page displayed in a second mode is displayed, where the first mode and the second mode are display modes provided by a same client. In this way, different display modes can be provided for a user, and the user is allowed to switch display modes as needed through the display mode switching control, so as to differentially meet content display requirements of different users and improve user experience.

### BRIEF DESCRIPTION OF DRAWINGS

To describe the technical solutions in embodiments of the application more clearly, the following briefly describes the accompanying drawings required for the description of the embodiments or the conventional technology. Clearly, the accompanying drawings in the following description show some embodiments of the application. Persons of ordinary skill in the art can till derive other drawings from these accompanying drawings without creative efforts.

Other features, objectives, and advantages of the application will become more obvious by reading the detailed description of the non-limiting embodiments made with reference to the following accompanying drawings.

FIG. 1 is a schematic flowchart of a process of providing a content display page according to an embodiment of the application;

FIG. 2 is a schematic diagram of an example effect of a content display page in a first mode according to an embodiment of the application;

FIG. 3 is a schematic diagram of an example effect of a content display page in a second mode according to an embodiment of the application;

FIG. 4 is a schematic diagram of a structure of an apparatus for providing a content display page according to an embodiment of the application; and

FIG. 5 is a schematic diagram of a structure of an electronic device applicable to implementing a solution in an embodiment of the application.

The same or similar reference numerals in the accompanying drawings represent the same or similar components.

### DESCRIPTION OF EMBODIMENTS

To make the objectives, technical solutions, and advantages of the embodiments of the application clearer, the technical solutions in the embodiments of the application are clearly described below with reference to the drawings in the embodiments of the application. Clearly, the described embodiments are some rather than all of the embodiments of the application. All other embodiments obtained by persons of ordinary skill in the art based on the embodiments of the application without creative efforts shall fall within the protection scope of the application.

In a typical configuration of the application, devices of a terminal and a service network each include one or more processors (CPUs), an input/output interface, a network interface, and a memory.

The memory may include a non-permanent memory such as a random access memory (RAM) in a computer-readable storage medium and/or a non-volatile memory such as a read-only memory (ROM) or a flash memory (flash RAM) in the computer-readable storage medium. The memory is an example of the computer-readable storage medium.

The computer-readable storage medium includes permanent and non-permanent, removable and non-removable media, and can implement information storage through any method or technology. The information may be computer program instructions, a data structure, a program means, or other data. Examples of a computer storage medium include, but are not limited to, a phase-change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disk (DVD) or another optical storage, a magnetic tape cassette, a magnetic tape storage or another magnetic storage device, or any other non-transmission medium, which can be used to store information that can be accessed by a computing device.

As discussed above, how to provide a user with better content acquisition experience is of concern and urgent need.

In some solutions, in a process of providing content display, although a user is allowed to adjust a manner of displaying content, in such a manner, not only does the user need to adjust various parameters frequently and repeatedly, which increases operation costs of the user, but also there are high requirements on adjustment capabilities of the user. For example, the user may need to simultaneously and synchronously adjust various parameters to coordinate various adjustments, thereby obtaining better viewing experience. Therefore, it is difficult for the user to obtain content efficiently, flexibly, and in a personalized manner.

In this regard, an embodiment of the application provides a method for providing a content display page, which is applied to a client. The method includes: displaying a content display page displayed in a first mode, where the content display page includes a content display area, and the content display area is correspondingly provided with a display mode switching control; and displaying, in response to a trigger operation on the display mode switching control, a content display page displayed in a second mode, where the first mode and the second mode are display modes provided by a same client.

In an actual scenario, an execution body of the method may be a client in user equipment or in a device formed by integrating the user equipment and a network device through a network. In other words, the execution body may be a client or an application program that runs on the foregoing device. The user equipment includes but is not limited to various terminal devices such as a computer, a mobile phone, a tablet computer, a smartwatch, and a wristband. The network device includes but is not limited to implementations such as a network host, a single network server, a plurality of network server sets, or a cloud computing-based computer set. Herein, the cloud is formed by a large number of hosts or network servers based on cloud computing, where the cloud computing is a type of distributed computing, and is a virtual computer formed by a group of loosely coupled computer sets.

In addition, in the technical solutions involved in the application, acquisition, storage, use, processing, transportation, provision, disclosure, and the like of user personal information (for example, user configuration information subsequently involved in the present disclosure) that is involved all comply with provisions of relevant laws and regulations, and do not violate public order and good morals.

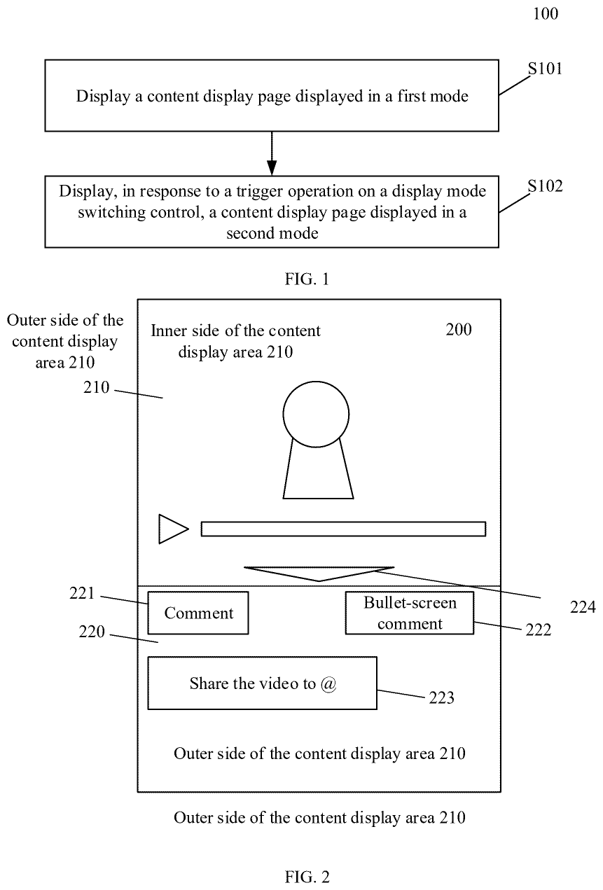

FIG. 1 shows a process 100 of providing a content display page according to an embodiment of the application. The process 100 includes at least the following processing steps:

(Step) S101: Display a content display page displayed in a first mode.

In this embodiment of the application, a user may use a client that is an execution body of the process of providing a content display page (by using a terminal device used by the user), to obtain the content display page.

For example, the terminal device may communicate with a server to request the server to provide content such as a picture or a video for being played in the execution body, so that the content is watched “online”.

A video is used as an example. For example, after selecting and indicating a target video that is expected to be watched, the user may send a play request for the target video to the execution body to request the server to provide the target video, or deliver a corresponding resource to the terminal device, so that the user can play the target video “online” through the execution body (the client) in the terminal device.

In some embodiments, the execution body may alternatively provide the user with “video recommendations”, so that the user can interact with the server to select a recommended video as the target video.

In this embodiment of the application, when displaying content, the execution body may actually determine and configure, based on a “display mode”, the content display page used to display content.

In addition, as discussed above, in order to meet different viewing experience of the user, there may be at least two “modes”, so that the user can perform overall configuration on display parameters and the like in a manner of switching the “modes”.

For example, the execution body may first provide and display content for the user in the first mode, that is, after determining content that the user expects to watch and obtain, the execution body may generate and display a corresponding content display page in the first mode.

Correspondingly, the content display page may include at least a content display area that is actually used to display content, so that the user actually “obtains content” through the content display area. For example, specific content of a video or an image is displayed through the content display area.

A display mode switching control may be further correspondingly disposed in the content display area. The display mode switching control may be used by the user to switch display “modes” of a current content display page. To be specific, the user may instruct the execution body to display and provide the content in another mode by triggering the display mode switching control in a process of watching and obtaining content.

For ease of understanding, a mode to which the display mode switching control is to be switched after being triggered may be referred to as a “second mode”.

A video is used as an example. In a selectable mode, the content display page may include a content display area, a display mode switching control correspondingly disposed in the content display area, and a user interaction area. For example, the user interaction area may include a control for the user to implement interaction between users, such as a comment control, a bullet-screen comment control, a control for providing a message, and a control for forwarding a video that are for a video. In this way, the user can obtain and use related controls and functions through the user interaction area to perform “interaction between users”.

In another selectable mode, the content display page may include a content display area, a display mode switching control that is correspondingly disposed in the content display area, and a description information display area for content. For example, the description information display area may include description information such as author information, introduction information, and synopsis information that are used to display a video.

Correspondingly, in a case in which, for example, the first mode is the foregoing mode including the user interaction area, the user may instruct to switch the content display page to the second mode (for example, the second mode may be the mode including the description information display area) by triggering the display mode switching control.

For another example, in a scenario in which content is an image, the first mode may be a mode in which the content is displayed in a manner of a single image in the content display area, whereas the second mode may be a mode in which the content is displayed in a manner of a plurality of images (such as a four-square grid or a nine-square grid) in the content display area.

In some embodiments, the user may determine, by configuring user configuration information in advance, whether the first mode is used by the user to perform display. For example, in the foregoing example, for an image, the user may instruct through the user configuration information whether the content is displayed in the manner of a single image.

Correspondingly, if the execution body receives a play request of a target device (for example, a terminal device used by the user) for a content, the execution body may determine whether the target device provides such user configuration information and the content indicated by the user configuration information.

If the execution body determines that the target device provides such user configuration information, and the user configuration information indicates that the content is displayed in the first mode, the execution body may choose, in response to such a case, to display the content display page displayed in the first mode.

In some embodiments, if the user does not configure or provide the user configuration information (that is, the target device cannot or does not provide the user configuration information to the execution body), after obtaining authorization from the target device, the execution body may choose to “refer to” a device pose of the target device to determine a more appropriate “mode”.

For example, corresponding “modes” may be configured in advance for different device poses (such as a landscape pose and a portrait pose). Correspondingly, after detecting and obtaining the device pose of the target device, the execution body may select a corresponding mode to display the content.

For example, the execution body may determine a display component or a screen direction of the target device by reading sensing devices such as an accelerometer and a gyroscope of the target device, and further determine a device pose based on a direction of the display component. For example, the execution body may determine a tilt angle of the target device based on the accelerometer, determine a rotation speed of the target device based on the gyroscope, and then determine the screen direction of the target device based on a combination of the tilt angle of the target device and the rotation speed of the target device, thereby determining whether the target device is in a landscape pose or a portrait pose.

For ease of understanding, a device pose corresponding to the first mode may be described as a target pose. Correspondingly, if the execution body detects that a current device pose of the target device is the target pose, the execution body chooses to display the content in the first mode, that is, display the content display page displayed in the first mode.

Similarly, in some embodiments, classification of device poses may be further refined with reference to differences of scenarios. For example, “poses” and corresponding modes are further classified based on a value range into which a value of a tilt angle of the target device relative to a horizontal direction falls.

Therefore, the execution body may automatically match a used mode based on a pose of the target device, thereby simplifying operations of the user, reducing user consumption, and improving content viewing and acquisition experience of the user. In addition, a play state and a device pose may be further correspondingly bundled to avoid an operational error caused by the inability to determine a play mode due to a lack of user configuration information, thereby improving system stability.

In some embodiments, if a play request of the target device for content is received, but the target device does not provide the user configuration information, the execution body may alternatively obtain, in response to such a case, historical user configuration information provided regarding the content by a group of historical users who played the content.

To be specific, in a case of lacking user configuration information of a current user, the execution body may alternatively choose to “infer” a selection tendency of the current user to the modes based on “reference” of the historical user configuration information used by the historical users for displaying content.

Specifically, if the target device does not provide or authorize the use of the user configuration information, the execution body may choose, in response to such a case, to obtain historical user configuration information provided regarding the target video by a group of historical users who played the target video. For example, a group of historical users may be other users who have requested or played the content within a historical period of time.

In some embodiments, in order to enhance reference value, the execution body may further set a specific standard for selection of the historical users. For example, for a video, the standard may be that a proportion of duration of the video played by a historical user selected as a reference to total duration of the video should be greater than or equal to a proportion threshold.

Then, the execution body determines a selection tendency of a group of historical users for the modes based on the historical user configuration information that is provided by the historical users in the group of historical users regarding the content.

For example, the execution body may separately collect statistics on a play mode selected by each historical user for the target video. Then, a play mode with a larger quantity is used as a selection tendency for the target video based on the statistical result.

If the selection tendency indicates that a group of historical users tend to select the first display mode, that is, for example, in a group of historical users, users who select the first mode is more than historical users who select the second mode, the execution body may next correspondingly choose to display content based on the first mode.

Therefore, in a case of lacking “user configuration information” of a current target device (or user), a selection tendency of historical users is used as a reference to “infer” the mode.

In some embodiments, in a case of lacking the user configuration information, the execution body may alternatively choose whether to use the first mode for display with reference to specific content of the first mode.

For example, if “description information” is provided in the first mode, the execution body may choose to determine, based on a length of the description information, whether to use the first mode.

For example, if the length of the information is greater than or equal to a length threshold (for example, the length threshold may be correspondingly preset based on a fact that it may be determined that quality of the description information meets the requirements of a predetermined “high quality” standard), the execution body may choose to use the first mode to increase an exposure rate of the “high quality” description information, so that the user can obtain information associated with the content more effectively and efficiently.

In some embodiments, a disposing position of the display mode switching control may correspond to a “mode”. For example, if the content display area in the first mode “completely” occupies the content display page, a disposing position in the first mode of the display mode switching control may be an inner side of the content display area (for example, a position at the inner side of the content display area, to which there is a preset distance from an angular vertex of the content display area at a lower right corner).

For another example, if the content display area in the second mode does not “completely” occupy the content display page, a disposing position in the second mode may be an outer side of the content display area (for example, a position in the content display page that is not occupied by the content display area).

In some embodiments, the disposing position of the display mode switching control may alternatively include both the inner side and the outer side of the content display area. To be specific, when the user operates at a distance around a boundary of the content display area, it may be considered that the display mode switching control is triggered. A specific distance may be set by persons skilled in the art according to an actual condition, which is not limited in this embodiment of the present invention.

It should be noted that display effects of the display mode switching control corresponding to the first mode and the second mode may be the same or different, which will not be described again in this embodiment of the present application.

Therefore, the disposing position of the display mode switching control may be adaptively adjusted based on mode differences, so that the display mode switching control can be more conveniently used.

In some embodiments, visual styles of the display mode switching control may alternatively correspond to the first mode and the second mode, respectively. To be specific, a visual style of the display mode switching control in the first mode and a visual style of the display mode switching control in the second mode may be different.

For example, visual styles of the display mode switching control in different modes may be a “circular icon”, an “elongated icon”, and the like.

It can be understood that the display mode switching control is not necessarily displayed in a form visible to naked eyes. For example, visibility of the display mode switching control may be controlled by persons skilled in the art by setting transparency or the like.

In some other optional embodiments, the display mode switching control is not necessarily a control superimposed on the content display page, but is a portion of the content display page. For example, the display mode switching control is a page element in the content display page. For example, the display mode switching control is a boundary line or an edge line of the content display area.

In some embodiments, a visual style of the display mode switching control may alternatively be associated with a disposing position thereof. For example, if the display mode switching control is disposed at the inner side of the content display area, a visual style of the display mode switching control may be an “elongated icon” parallel to an edge on a side of the content display area. For example, at least one edge of the elongated icon may be actually disposed on an edge of (the inner side of) the content display area.

Generally, the user may actually trigger the display mode switching control through a single-tap or double-tap trigger operation. For example, the execution body (or more specifically, a device on which the execution body is installed) may detect whether a “trigger operation” exists by detecting whether a single-tap or double-tap behavior on the display mode switching control exists.

In some embodiments, the display mode switching control may be further configured to be triggered in a “drag” manner. In some embodiments, in order to enable the user to more intuitively understand operation progress when the user performs the trigger operation based on a drag action, the execution body may further interact with the user by adding a progress bar and displaying a target distance corresponding to a distance threshold to prompt the user, so that the user can more efficiently and accurately perform the trigger operation.

In some embodiments, the execution body may further configure a direction of the “drag action”. For example, the direction corresponds to a specific mode used. For example, the direction may be vertical upward in the first mode, and the direction may be vertical downward in the second mode.

Correspondingly, the execution body may continuously detect a position change of the display mode switching control. If it is detected that a drag distance of the display mode switching control dragged in a target direction is greater than or equal to the distance threshold, the execution body may determine, in response to such a case, that the trigger operation on the display mode switching control exists.

In this way, the user may trigger the display mode switching control in a manner of dragging in the target direction, so that the user more flexibly selects a manner of triggering and using the display mode switching control in combination with the requirements of the user.

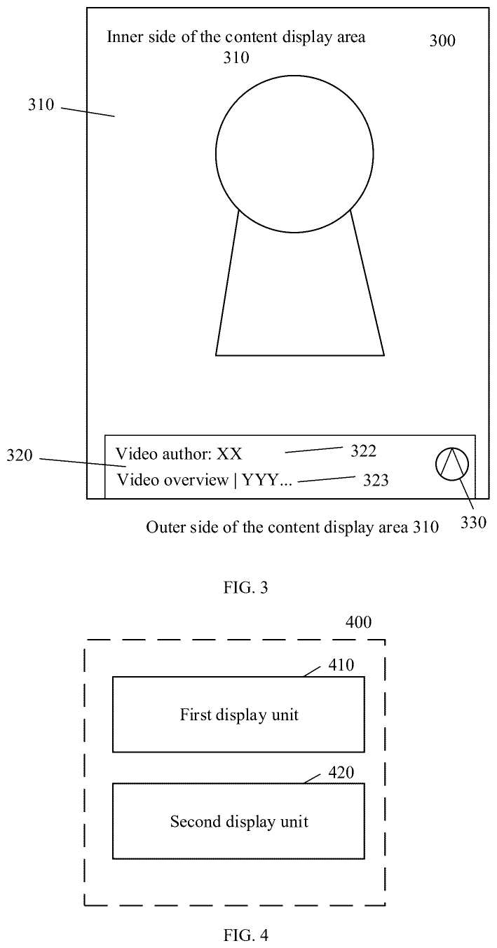

For ease of understanding, reference may be still made to FIG. 2 and FIG. 3. FIG. 2 is a schematic diagram of an example effect of a content display page in a first mode according to an embodiment of the application. FIG. 3 is a schematic diagram of an example effect of a content display page in a second mode according to an embodiment of the application.

First, referring to FIG. 2, a video is still used as an example, and a content display page 200 may be in the first mode. The content display page 200 may include a content display area 210 (in which, for example, video content may be displayed).

For example, a user interaction area 220 may be further provided in the first mode. For example, the first mode indicates that, based on a predetermined “screen-to-body ratio”, the content display page 200 displays the content display area 210, and the user interaction area 220 that is independent of the content display area 210, and provides a display mode switching control 224 at a position at the inner side of the content display area 210 displayed, to which there is a preset distance from a lower edge of the content display area 210 displayed.

It should be understood that the foregoing disposing position of the display mode switching control 224 is merely an example description made for ease of understanding. In some embodiments, for example, such a display mode switching control 224 may alternatively be disposed at the outer side of the content display area 210 (for example, in the user interaction area 220 or at another position between the user interaction area 220 and the content display area 210).

Correspondingly, a comment control 221, a bullet-screen control 222, and a video sharing control 223 may be provided in the user interaction area 220, so that the user can implement “interaction” through these controls.

Further, if the execution body detects a trigger operation on the display mode switching control 224 (for example, a distance of the display mode switching control 224 dragged vertically downward is greater than or equal to the distance threshold), the execution body may display, in response to such a case, the content display page displayed in the second mode.

In this regard, reference may be still made to FIG. 3.

For example, the second mode indicates to provide a content display area and a display mode switching control, and further display a description information area in the content display area.

Correspondingly, based on the mode being switched, in the second mode, in a content display page 300 shown in FIG. 3, content of the video may continue to be displayed based on a content display area 310 (that is, by using the content display area 310, the video may continue to be played according to the play progress of the video played by using the content display area 210 when the mode is switched).

Compared with the first mode, in addition to displaying the “video”, the content display area 310 in the content display page 300 in the second mode may further display, by using a description information display area 320 (which may be, for example, understood as a sub-area of the content display area 310) that is included in the content display area 310 and that is a portion of the content display area 310, for example, author information 322 and video introduction information 323 of the video.

Similarly, for example, for the display mode switching control 330 in the second mode, a disposing position thereof may be at the inner side of the content display area 310, to which there is a preset distance from an angular vertex of the content display area 310 at a lower right corner.

As discussed above, the display mode switching control 224 and the display mode switching control 330 may have different “visual styles” based on differences between the first mode and the second mode.

For example, in a case in which both the display mode switching control 224 and the display mode switching control 330 may be triggered by a “drag operation”, a visual style corresponding to each of the display mode switching control 224 and the display mode switching control 330 may be related to a “target direction” corresponding to a drag thereof.

For example, in a case in which the display mode switching control 224 is dragged in a “vertical downward” manner to be triggered, a corresponding visual style of the display mode switching control 224 may be shown in FIG. 2; and in a case in which the display mode switching control 330 is dragged in a “vertical upward” manner to be triggered, a corresponding visual style of the display mode switching control 330 may be shown in FIG. 3.

S102: Display, in response to a trigger operation on the display mode switching control, a content display page displayed in a second mode.

In this embodiment of the application, as discussed above, if the display mode switching control is triggered by a trigger operation on the display mode switching control, the execution body may choose, in response to such a case, to display the content display page displayed in the second mode.

As discussed above, the second mode may be a display mode that is different from the first mode and that is provided by the execution body, that is, the same client.

Then, the method for providing a content display page provided in the application is applied to a client and includes: displaying a content display page displayed in a first mode, where the content display page includes a content display area, and a display mode switching control is correspondingly disposed in the content display area; and displaying, in response to a trigger operation on the display mode switching control, a content display page displayed in a second mode, where the first mode and the second mode are display modes provided by a same client. In this way, different display modes can be provided for the user, and the user is allowed to switch display modes as needed through the display mode switching control, to differentially meet content display requirements of different users and improve user experience.

In some embodiments, if the display mode switching control is configured or disposed in the content display area, transparency of the display mode switching control may alternatively be reduced at discretion to alleviate impact of the display mode switching control on the content display area.

For example, in a case of detecting that the display mode switching control is not triggered within a preset duration, the execution body may reduce the transparency of the visual style of the display mode switching control to target transparency, so that the display mode switching control can make the displayed content more “transparent”.

Similarly, in a case in which the display mode switching control is not triggered within the preset duration, the execution body may alternatively choose to reduce a size of the visual style of the display mode switching control or directly hide the switching control, so that the display mode switching control can make the displayed content more “transparent”.

Next, the execution body may at least detect (the visual style of) the display mode switching control that has been adjusted (for example, reduced in transparency or reduced in size). If the display mode switching control is tapped (for example, single tapped) or touched by the user, the execution body may correspondingly restore the display mode switching control (for example, restore the transparency or size of the display mode switching control), so that the display mode switching control is used by the user. In this way, the needs for a “transparent” effect and user convenience are balanced.

As discussed above, in order to make the displayed content transparent to “the maximum extent”, the display mode switching control may alternatively be hidden at discretion. In this case, the execution body may choose to configure a target area in the content display page. Generally, the target area may actually be located in the content display area, to avoid occupying the content display area due to disposing the target area independently of the content display area.

In some embodiments, the target area is obtained, through extension, starting from an area edge line of the content display area and closest to a disposing position of the content display area, in a direction pointing to the disposing position, and the target area includes the disposing position.

Therefore, an area that is closest to the display mode switching control and that includes the display mode switching control, which is in an “edge area” or a “border area” of the content display area may be used as a reference. Next, if the execution body detects that the user performs a “drag operation on the content display area” or a “tap operation” in the target area, the execution body may correspondingly redisplay the hidden display mode switching control for the user to use.

Therefore, in a case in which the display mode switching control is hidden, the target area may be used as a “trigger” or “detection” area to interact with the user, to obtain a “use expectation” of the user for the display mode switching control.

It should be understood that, in some embodiments, even if the execution body does not hide the display mode switching control (for example, merely reduces transparency of the display mode switching control or a size of an icon of the display mode switching control), the execution body may alternatively choose to configure such a target area in the foregoing manner to reduce operation costs of the user (for example, the user may directly indicate, through a drag operation or a tap operation behavior, for example, on the content display area in the target area, to the execution body that the user expects to use the display mode switching control).

An embodiment of the application further provides an apparatus for providing a content display page, which is applied to a client. A structure of the apparatus is, for example, an apparatus 400 shown in FIG. 4. The apparatus 400 includes: a first display unit 410, configured to display a content display page displayed in a first mode, wherein the content display page includes a content display area, and the content display area is correspondingly provided with a display mode switching control; and a second display unit 420, configured to display, in response to a trigger operation on the display mode switching control, a content display page displayed in a second mode, wherein the first mode and the second mode are display modes provided by a same client.

In some embodiments, the apparatus 400 further includes: a position change detection unit, configured to detect a position change of the display mode switching control; and a trigger operation determining unit, configured to determine, in response to detecting that a drag distance of the display mode switching control dragged in a target direction is greater than or equal to a distance threshold, that the trigger operation on the display mode switching control exists.

In some embodiments, the apparatus 400 further includes: a mode switching control hiding unit, configured to hide the display mode switching control in response to the display mode switching control not being triggered within a preset duration.

In some embodiments, the apparatus 400 further includes: a hidden control redisplay unit, configured to redisplay the hidden display mode switching control in response to detecting a drag operation or a tap operation triggered in a content display area within a target area, wherein the target area is obtained through extension, starting from an area edge line of the content display area and closest to a disposing position of the content display area, in a direction pointing to the disposing position, and the target area includes the disposing position.

In some embodiments, visual styles of the display mode switching control correspond to the first mode and the second mode, respectively.

In some embodiments, the first display unit is further configured to: display, in response to receiving a play request of a target device for the content, and user configuration information provided by the target device indicating that the content is to be displayed in the first mode, the content display page displayed in the first mode.

In some embodiments, the first display unit is further configured to: obtain, in response to receiving the play request of the target device for the content, and the target device not providing the user configuration information, a current device pose of the target device; and display, in response to the current device pose being the target pose, the content display page displayed in the first mode.

In some embodiments, the first display unit is further configured to: obtain, in response to receiving the play request of the target device for the content, and the target device not providing the user configuration information, historical user configuration information provided regarding the content by a group of historical users who played the content; and display the content display page displayed in the first mode in response to determining the group of historical users tend to select the first display mode based on the historical user configuration information.

Based on a same inventive concept, embodiments of the application further provide an electronic device, a readable storage medium, and a computer program product. A method corresponding to the electronic device may be the method for providing a content display page in the foregoing embodiments, and a principle of solving problems in the method corresponding to the electronic device is similar to that in the method for providing a content display page. The electronic device provided in the embodiments of the application includes: at least one processor; and a memory that is communicatively connected to the at least one processor. The memory stores instructions executable by the at least one processor, and the instructions are executed by the at least one processor, so that the at least one processor can perform the methods and/or technical solutions in a plurality of foregoing embodiments of the application.

The electronic device may be user equipment, a device formed by integrating the user equipment and a network device through a network, or an application program that runs on the foregoing device. The user equipment includes but is not limited to various terminal devices such as a computer, a mobile phone, a tablet computer, a smartwatch, and a wristband. The network device includes but is not limited to implementations such as a network host, a single network server, a plurality of network server sets, or a cloud computing-based computer set, which may be used to implement some processing functions when an alarm is set. Herein, the cloud is formed by a large number of hosts or network servers based on cloud computing, where the cloud computing is a type of distributed computing, and is a virtual computer formed by a group of loosely coupled computer sets.

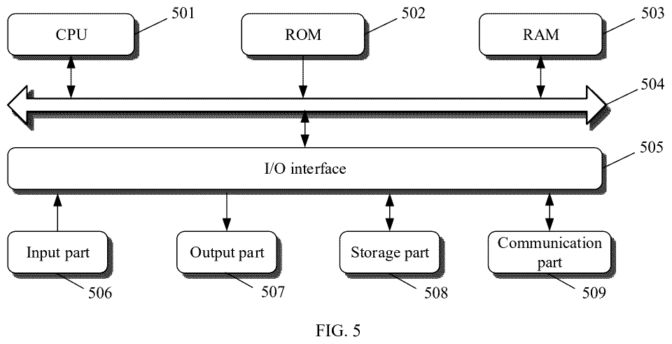

FIG. 5 shows a structure of an electronic device applicable to implementing the methods and/or the technical solutions in the embodiments of the application. The electronic device 500 includes a central processing unit (CPU) 501, which may perform various proper actions and processes according to a program stored in a read-only memory (ROM) 502 or a program loaded from a storage part 508 to a random access memory (RAM) 503. The RAM 503 further stores various programs and data required for system operation. The CPU 501, the ROM 502, and the RAM 503 are connected to each other through a bus 504. An input/output (I/O) interface 505 is also connected to the bus 504.

The following components are connected to the I/O interface 505: an input part 506 including a keyboard, a mouse, a touchscreen, a microphone, an infrared sensor, and the like; an output part 507 including a cathode ray tube (CRT), a liquid crystal display (LCD), a LED display, an OLED display, and a speaker; a storage part 508 including one or more computer-readable storage media such as a hard disk, an optical disc, a magnetic disk, and a semiconductor memory; and a communication part 509 including a network interface card such as a local area network (LAN) card and a modem. The communication part 509 performs communication processing through a network such as the Internet.

In particular, the method and/or the embodiment in the embodiments of the application may be implemented as a computer software program. For example, an embodiment disclosed in the application includes a computer program product, which includes a computer program carried on a computer-readable storage medium, and the computer program includes program code used to perform the method shown in the flowchart. When the computer program is executed by the central processing unit (CPU) 501, the foregoing functions defined in the method in the application are performed.

Another embodiment of the application further provides a computer-readable storage medium and a computer program product, on which computer program instructions are stored, and the computer program instructions may be executed by a processor to implement the methods and/or the technical solutions in any one or more of the foregoing embodiments of the application.

Specifically, any combination of one or more computer-readable media may be used in the embodiment. The computer-readable medium may be a computer-readable signal medium or a computer-readable storage medium. The computer-readable storage medium may be, for example, a system, an apparatus, or a device that includes but is not limited to electrical, magnetic, optical, electromagnetic, infrared, or semiconductor, or any combination thereof. A more specific example (non-exhaustive list) of a computer-readable storage medium includes: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In this document, the computer-readable storage medium may be any tangible medium that includes or stores a program, and the program may be used by or in combination with an instruction execution system, apparatus, or device.

The computer-readable signal medium may include a data signal propagated in a baseband or as part of a carrier, and carries computer-readable program code. Such a propagated data signal may be in a variety of forms, including but not limited to an electromagnetic signal, an optical signal, or any suitable combination thereof. The computer-readable signal medium may alternatively be any computer-readable medium other than the computer-readable storage medium, which may send, propagate, or transmit a program for use by or in combination with an instruction execution system, apparatus, or device.

The program code included in the computer-readable medium may be transmitted by using any suitable medium, including but not limited to wireless, wire, optical cable, RF, or the like, or any suitable combination thereof.

Computer program code for performing operations in the application may be written in one or more programming languages or a combination thereof. The programming languages include object-oriented programming languages such as Java, Smalltalk, C++, and further include conventional procedural programming languages such as “C” or similar programming languages. The program code may be executed completely on a user computer, partially on a user computer, as a stand-alone software package, partially on a user computer and partially on a remote computer, or completely on a remote computer or server. In a case involving a remote computer, the remote computer may be connected to a user computer through any type of network, including a local area network (LAN) or a wide area network (WAN), or may be connected to an external computer (for example, through the Internet by using an Internet service provider).

The flowcharts or block diagrams in the accompanying drawings show architectures, functions, and operations possibly implemented by devices, methods, and computer program products according to various embodiments of the application. In this regard, each block in a flowchart or block diagram may represent a portion of one means, program segment, or code, which includes one or more executable instructions for implementing a specified logical function. It should also be noted that in some alternative implementations, functions marked in blocks may occur in an order different from the order marked in the accompanying drawings. For example, two blocks shown in succession may actually be executed substantially in parallel, or may sometimes be executed in a reverse order, depending on the functions involved. It should also be noted that each block in the block diagram and/or flowchart and a combination of blocks in the block diagram and/or flowchart may be implemented by using a dedicated hardware-specific system that performs a specified function or operation, or may be implemented by using a combination of dedicated hardware and computer instructions.

It may be clearly understood by persons skilled in the art that, for convenience and brevity of the descriptions, for a detailed working process of the above-described system, apparatus, and unit, refer to the corresponding process in the foregoing method embodiments. Details are not described herein again.

In the several embodiments provided in the application, it should be understood that the disclosed system, apparatus, and method may be implemented in another manner. For example, the apparatus embodiments described above are merely examples. For example, classification into means and units is merely a logical function classification. In actual implementation, there may be another classification manner. Units are used as an example. For example, a plurality of units or page components may be combined or integrated into another system, or some features may be ignored or not executed. In another aspect, the mutual coupling or direct coupling or communication connection shown or discussed may be an indirect coupling or communication connection of apparatuses or units through some interfaces, and may be in an electrical, mechanical, or another form.

Units described as separate parts may or may not be physically separated, and parts displayed as units may or may not be physical units, that is, may be located at one position, or may be distributed on a plurality of network units. Some or all of the units may be selected based on an actual need to achieve the objective of the solutions of this embodiment.

In addition, functional modules and units in the embodiments of the application may be integrated into one processing modules and unit, or the modules and units may exist physically separately, or two or more units may be integrated into one module and unit. The foregoing integrated unit may be implemented in a form of hardware, or may be implemented in a form of hardware plus software functional means and units.

The foregoing integrated modules and units implemented in a form of software functional modules and units may be stored in a computer-readable storage medium. The foregoing software functional means and units are stored in a storage medium and include several instructions for enabling a computer device (which may be a personal computer, a server, a network device, or the like) or a processor to perform some of the steps in the methods in the embodiments of the application. The foregoing storage medium includes any medium that can store program code, such as a USB flash drive, a removable hard disk, a read-only memory (ROM), a random access memory (RAM), a magnetic disk, or an optical disc.

Finally, it should be noted that the foregoing embodiments are merely intended for describing, instead of limiting, the technical solutions of the application. Although the application is described in detail with reference to the foregoing embodiments, persons of ordinary skill in the art should understand that they can still make modifications to the technical solutions described in the foregoing embodiments or make equivalent replacements to some technical features thereof. These modifications or replacements do not make the essence of the corresponding technical solutions depart from the spirit and scope of the technical solutions of the embodiments of the application.

In addition, it is clear that the word “include” does not exclude other units or steps, and a singular form does not exclude a plural form. A plurality of units or apparatuses described in the apparatus claims may alternatively be implemented by one unit or apparatus through software or hardware. Words such as first and second are used to represent names, and do not represent any particular order.

What is claimed is:

1. A method for providing a content display page, applied to a client, comprising:
displaying a content display page displayed in a first mode, wherein the content display page comprises a content display area, and the content display area is correspondingly provided with a display mode switching control; and
displaying, in response to a trigger operation on the display mode switching control, a content display page displayed in a second mode, wherein the first mode and the second mode are display modes provided by a same client.

2. The method according to claim 1, further comprising:
detecting a position change of the display mode switching control; and
determining, in response to detecting a drag distance of the display mode switching control dragged in a target direction is greater than or equal to a distance threshold, the trigger operation on the display mode switching control exists.

3. The method according to claim 1, further comprising:
hiding the display mode switching control in response to the display mode switching control not being triggered within a preset duration.

4. The method according to claim 3, further comprising:
redisplaying the hidden display mode switching control in response to detecting a drag operation or a tap operation triggered in a content display area within a target area, wherein the target area is obtained through extension, starting from an area edge line of the content display area closest to a disposing position of the content display area, in a direction pointing to the disposing position, and the target area comprises the disposing position.

5. The method according to claim 1, wherein visual styles of the display mode switching control correspond to the first mode and the second mode, respectively.

6. The method according to claim 1, wherein the displaying a content display page displayed in a first mode comprises:
displaying, in response to receiving a play request of a target device for a content, and user configuration information provided by the target device indicating the content is to be displayed in the first mode, the content display page displayed in the first mode.

7. The method according to claim 6, wherein the displaying a content display page displayed in a first mode further comprises:
obtaining, in response to receiving the play request of the target device for the content, and the target device not providing the user configuration information, a current device pose of the target device; and
displaying, in response to the current device pose being a target pose, the content display page displayed in the first mode.

8. The method according to claim 6, wherein the displaying a content display page displayed in a first mode further comprises:
obtaining, in response to receiving the play request of the target device for the content, and the target device not providing the user configuration information, historical user configuration information provided regarding the content by a group of historical users who played the content; and
displaying, in response to determining the group of historical users tend to select the first display mode based on the historical user configuration information, the content display page displayed in the first mode.

9. An apparatus for providing a content display page, applied to a client, and comprising:
a first display unit, configured to display a content display page displayed in a first mode, wherein the content display page comprises a content display area, and the content display area is correspondingly provided with a display mode switching control; and
a second display unit, configured to display, in response to a trigger operation on the display mode switching control, a content display page displayed in a second mode, wherein the first mode and the second mode are display modes provided by a same client.

10. A computer-readable storage medium, wherein the computer-readable storage medium stores computer program instructions, and the computer program instructions are executable by a processor to implement following steps:
displaying a content display page displayed in a first mode, wherein the content display page comprises a content display area, and the content display area is correspondingly provided with a display mode switching control; and
displaying, in response to a trigger operation on the display mode switching control, a content display page displayed in a second mode, wherein the first mode and the second mode are display modes provided by a same client.

11. The computer-readable storage medium according to claim 10, the computer program instructions are further executable by the processor to implement following steps:
detecting a position change of the display mode switching control; and
determining, in response to detecting a drag distance of the display mode switching control dragged in a target direction is greater than or equal to a distance threshold, the trigger operation on the display mode switching control exists.

12. The computer-readable storage medium according to claim 10, the computer program instructions are further executable by the processor to implement following steps:
hiding the display mode switching control in response to the display mode switching control not being triggered within a preset duration.

13. The computer-readable storage medium according to claim 12, the computer program instructions are further executable by the processor to implement following steps:
redisplaying the hidden display mode switching control in response to detecting a drag operation or a tap operation triggered in a content display area within a target area, wherein the target area is obtained through extension starting from an area edge line of the content display area closest to a disposing position of the content display area, in a direction pointing to the disposing position, and the target area comprises the disposing position.

14. The computer-readable storage medium according to claim 10, wherein visual styles of the display mode switching control correspond to the first mode and the second mode, respectively.

15. The computer-readable storage medium according to claim 10, wherein the displaying a content display page displayed in a first mode comprises:
displaying, in response to receiving a play request of a target device for a content, and user configuration information provided by the target device indicating the content is to be displayed in the first mode, the content display page displayed in the first mode.

16. The computer-readable storage medium according to claim 15, wherein the displaying a content display page displayed in a first mode further comprises:
obtaining, in response to receiving the play request of the target device for the content, and the target device not providing the user configuration information, a current device pose of the target device; and
displaying, in response to the current device pose being a target pose, the content display page displayed in the first mode.

17. The computer-readable storage medium according to claim 15, wherein the displaying a content display page displayed in a first mode further comprises:
obtaining, in response to receiving the play request of the target device for the content, and the target device not providing the user configuration information, historical user configuration information provided regarding the content by a group of historical users who played the content; and
displaying, in response to determining the group of historical users tend to select the first display mode based on the historical user configuration information, the content display page displayed in the first mode.

18. A computer program product, comprising a computer program, wherein when the computer program is executed by a processor, following steps are implemented:
displaying a content display page displayed in a first mode, wherein the content display page comprises a content display area, and the content display area is correspondingly provided with a display mode switching control; and
displaying, in response to a trigger operation on the display mode switching control, a content display page displayed in a second mode, wherein the first mode and the second mode are display modes provided by a same client.

19. The computer program product according to claim 18, when the computer program is executed by a processor, following steps are further implemented:
detecting a position change of the display mode switching control; and
determining, in response to detecting a drag distance of the display mode switching control dragged in a target direction is greater than or equal to a distance threshold, the trigger operation on the display mode switching control exists.

20. The computer program product according to claim 18, when the computer program is executed by a processor, following steps are further implemented:
hiding the display mode switching control in response to the display mode switching control not being triggered within a preset duration.
